(19) United States
(12) Patent Application Publication
(10) Pub. No.: US 2011/0030816 A1
(43) Pub. Date: Feb. 10, 2011

(54) CONTROL SYSTEM FOR CONTROLLING A DIRECTIONAL CONTROL VALVE

(76) Inventor: Wolfgang Kauss, Francheville (DE)

Correspondence Address: MICHAEL J. STRIKER, 103 EAST NECK ROAD, HUNTINGTON, NY, 11743, US

(21) Appl. No.: 12/936,366

(22) PCT Filed: Apr. 8, 2009
(86) PCT No.: PCT/EP2009/002595

§ 371 Date: Oct. 4, 2010

(30) Foreign Application Priority Data
Apr. 15, 2008 (DE) 102008018936.7

(51) Int. Cl. F16K 31/36

(52) U.S. Cl. 137/488

(57) ABSTRACT

The invention relates to a control arrangement with a pilot aggregate (6) for controlling a control valve (2) comprising a first and a second control chamber (36, 38). The first control chamber (36) is provided for adjusting the control valve (2) in one direction and the second control chamber (38) for adjusting the control valve in the opposite direction. The control chambers (36, 38) are applied each with a pilot pressure of the pilot aggregate (6). Besides the pilot aggregate (5), the control arrangement further comprises a pilot valve (4) for applying a control chamber (36, 38) with an outlet pressure. The supply pressure of the pilot valve (4) is hereby the pilot pressure of the pilot aggregate (6) effective in one of the control chambers (36, 38) and the output pressure of the pilot valve (4) is effective in the other control chamber (36, 38), wherein the output pressure is equal or smaller than the pilot pressure.

The invention relates to a control system for controlling a directional valve according to the preamble of claim 1.

In cases where the volumetric flow rate of pressure medium is high, a pilot control valve is often provided to control a directional valve; the pilot control valve can be designed as a mechanical-hydraulic pilot control assembly for mobile working units. A pilot control assembly of that type is known e.g. from data sheet RD 64 552 from the applicant. The pilot control assembly has a large number of adjustable pressure reducing valves which are actuated manually using a control lever. The level of the pilot control pressure is dependent on the position of the control lever, thereby resulting in proportional-hydraulic control of the directional valve. The structural design of a pilot control assembly of this type is known e.g. from DE 27 51 946 C2 or DE 199 49 802 A1. Electrohydraulic pilot control can be provided instead of or as an alternative to the mechanical-hydraulic pilot control of the directional valve.

According to DE 10 2005 005 928, a mechanical-hydraulic pilot control is combined with an electrohydraulic pilot control of a directional valve. In that case, the highest pilot control pressure set at the pilot control assembly or the electrically adjustable pilot control valve is present in a control chamber of the directional valve. The disadvantage of this solution is that, when a fault occurs in the control electronics of the electrically adjustable pilot control valve, the latter could adjust the directional valve in an unpredictable manner, which results in dangerous situations when used in a control system of that type.

In contrast, the object of the invention is to create a control system that has a simple design and is safe to use.

The object is solved by a control system having the features of claim 1.

According to the invention, a control system comprises a pilot control assembly for controlling a directional valve that includes a first and a second control chamber. The first control chamber is used to displace the directional valve in one direction, and the second control chamber is used to displace the directional valve in the opposite direction, wherein one of the control chambers is acted upon by a pilot control pressure of the pilot control assembly. In addition to the pilot control assembly, the control system also comprises a pilot control valve for applying an outlet pressure to one of the control chambers. The supply pressure of the pilot control valve is the pilot control pressure of the pilot control assembly that is effective in the initially mentioned control chamber, and the outlet pressure of the pilot control valve is effective in the other control chamber, wherein the outlet pressure is equal to or less than the pilot control pressure.

This solution has the advantage that the pilot control valve is controlled open only as a function of the pilot control pressure of the pilot control assembly, and so, e.g. if the pilot control valve malfunctions, the directional valve cannot be moved in the direction opposite to that specified by the pilot control assembly. At the most, an equilibrium position of the directional valve can be achieved since the maximum possible outlet pressure is equal to the pilot control pressure.

Advantageously, the pilot control valve is an electromagnetic pressure reducing valve which can be used to easily adjust the outlet pressure that is effective in a control chamber.

The pilot control assembly can be a cost-effective standard component, and is connected e.g. by a pilot control line to a control chamber of the directional valve, wherein, using the pilot control assembly, one of the pilot control lines can be connected for the supply of control oil to a control-oil supply line, and the respective other pilot control line can be relieved to a tank.

A supply line of the pilot control valve preferably has a control oil connection to the highest-pressure pilot control line of the pilot control valve, wherein the highest-pressure pilot control line is connected to one of the control chambers of the directional valve, and the other control chamber can be connected to the supply line or the lower-pressure pilot control line by adjusting the pilot control valve. In a simple embodiment, the pilot control valve can therefore be supplied with the pilot control pressure of the pilot control assembly.

A cascade of shuttle valves makes it possible to easily tap the higher of the pilot control pressures of the pilot control assembly, which is the supply pressure of the pilot control valve and ensures that the outlet pressure of the pilot control valve is applied to the other control chamber. In that case, two outlet ports of the pilot control assembly are each advantageously connected to one of the pilot control lines, each of which leads to an inlet port of two pilot-operated directional valves. Another inlet port of the pilot-operated directional valves is connected via connecting lines and a common outlet line to a working port of the pilot control valve. Furthermore, one outlet port of the pilot-operated directional valves is connected via a control line to one of the control chambers of the directional valve, and via a supply line to an inlet port of a shuttle valve, the outlet port of which is connected to the pressure port of the pilot control valve.

To enable pressure to be relieved to a tank, the pilot control valve can be connected to a tank port via a tank line with an outlet port of an inverse directional control valve, wherein each of the inlet ports of the inverse directional valve is connected via a low-pressure line to one of the pilot control lines.

An actuator, e.g. in the form of a hydraulic cylinder, can be connected in a known manner via a piston-rod side annular chamber to a working line, and via a base-side cylinder chamber to another working line of the directional valve.

Preferably, a microcontroller operates the pilot control valve as a function of the displacement travel of a piston of the hydraulic cylinder, and/or a control-oil pressure in the highest-pressure working line between the hydraulic cylinder and the directional valve, and/or a control-oil pressure in the supply line to the pilot control valve. This is advantageous since, depending on the conditions under which the control system is used, the directional valve can be acted upon by a different outlet pressure—which is controlled by the microcontroller—of the pilot control valve, thereby enabling e.g. the displacement speed of the valve spool of the directional valve to be controlled. Electronic flow matching (EFM) is also made possible as a result.

According to an advantageous embodiment, the control system controls at least two actuators, to each of which a control system is assigned, wherein the pilot control valve assigned to one of the actuators is acted upon via a valve system with the pilot control pressure, as the supply pressure, of the first pilot control assembly assigned to the other actuator. It is thereby made possible for one pilot control assembly to control two actuators.

To ensure that only the first pilot control assembly can control both actuators, the valve system comprises e.g. two connecting directional valves, the inlet ports of which are each connected to connecting channels that branch off from the pilot control lines of the first pilot control assembly, and to the pilot control lines of the second pilot control assembly, the respective outlet port of which being connected to the inlet port of the first pilot-operated directional valves and to the inlet port of the inverse directional valve of the cascade of shuttle valves which is assigned to the pilot control valve for the one actuator.

A closable switching valve can be disposed in the control oil flow path between the first pilot control assembly and the respective connecting directional valve, advantageously to regulate a control of the other actuator using the first pilot control assembly.

By way of the switching valve, tank pressure or the pilot control pressure of the first pilot control assembly can be applied to the inlet ports of the connecting directional valves, which are connected to the first pilot control assembly.

The pilot control valves are controlled by a common microcontroller, thereby enabling them to be controlled in a flexible manner.

Advantageous developments of the invention are the subject matter of further dependent claims.

Preferred embodiments are explained below in greater detail with reference to the schematic drawings. They show:

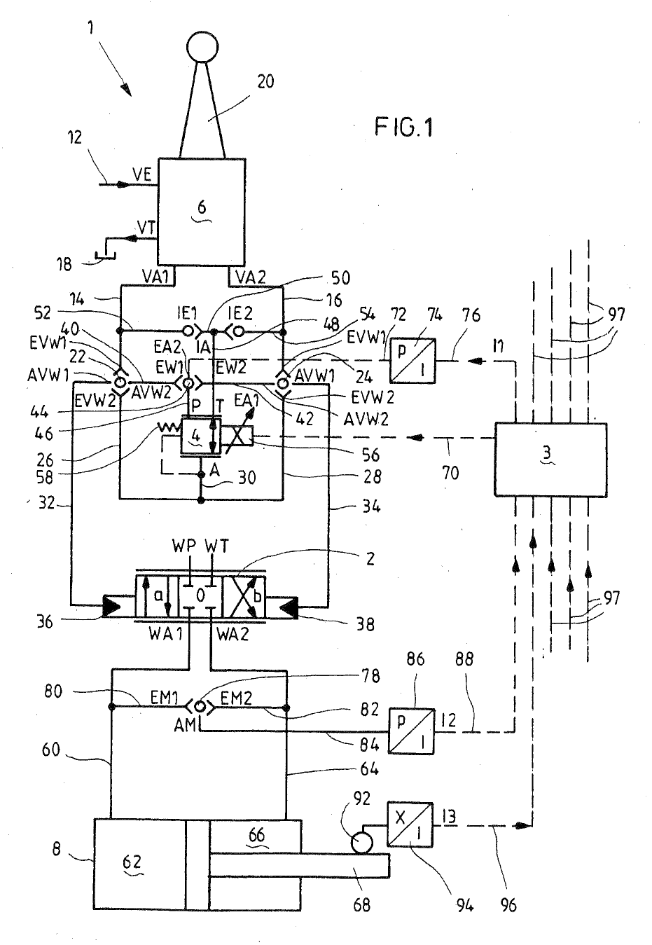

FIG. 1 a schematic circuit diagram of a control system for controlling a directional valve according to a first embodiment;

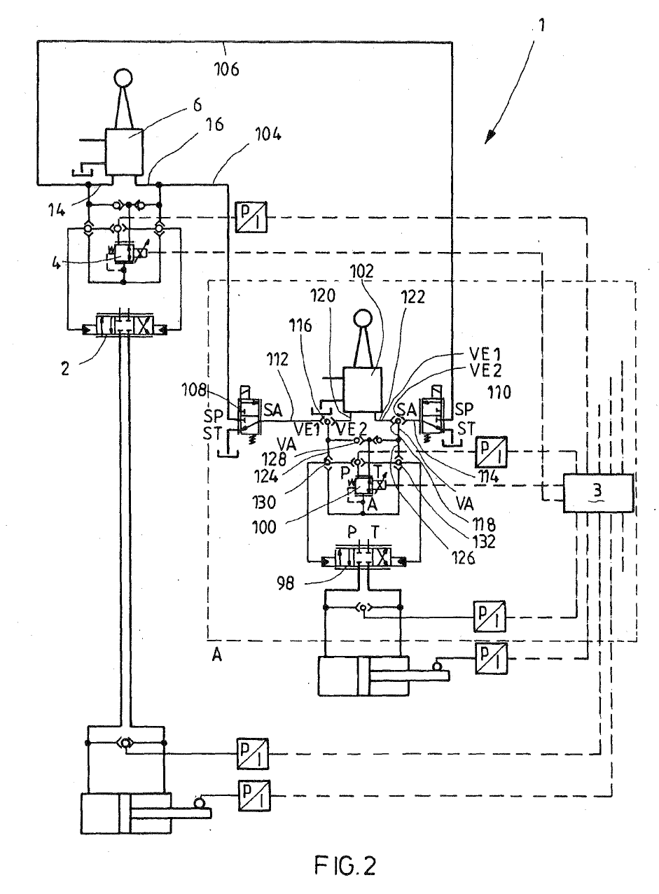

FIG. 2 a schematic circuit diagram of the control system according to a second embodiment; and

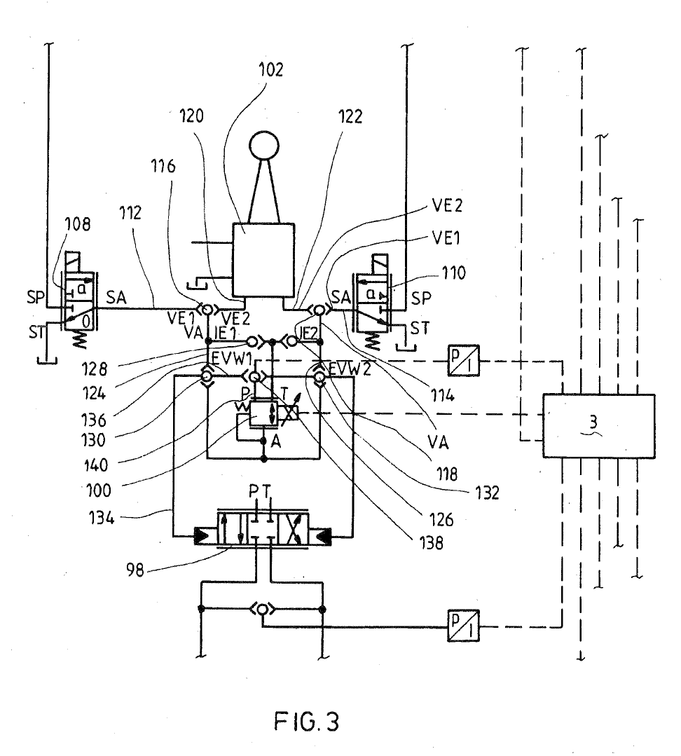

FIG. 3 an enlarged section A of the schematic circuit diagram of the control system depicted in FIG. 2.

FIG. 1 shows a schematic circuit diagram of a control system 1 for controlling a directional valve 2 according to a first embodiment. Directional valve 2 can be adjusted using a pilot control valve 4 that is controlled by a microcontroller 3, and/or by a pilot control assembly 6, wherein an actuator in the form of a hydraulic cylinder 8 is connected to directional valve 2. A control system 1 of that type can be used e.g. in mobile hydraulics for tractor backhoe loaders, mini-excavators and compact excavators.

Pilot control assembly 6 is basically an adjustable pressure reducing valve that is actuated manually. A detailed description thereof is provided e.g. in aforementioned documents DE 27 51 946 C2 or DE 199 49 802 A1. Pilot control assembly 6 has an inlet port VE to which a control oil supply line 12 is connected, two outlet ports VA1, VA2, each of which is connected to a pilot control line 14, 16, respectively, and a tank port VT which is connected to a tank 18. Using a control lever 20 of pilot control assembly 6, control oil supply line 12 can be connected to pilot control line 14 or 16 to supply control oil, wherein respective pilot control line 14, 16 that is not connected to control oil supply line 12 is connected to tank 18, and wherein the level of the pilot control pressure in pilot control line 14 or 16 is dependent on the position of control lever 20 which lowers the supply pressure in control oil supply line 12, via the pressure reducing valves, to the required pilot control pressure. When the pilot control assembly is not actuated, both pilot control lines 14, 16 are relieved to tank 18.

Pilot control lines 14, 16 each lead to a first inlet port EVW1 of a pilot-operated directional valve 22, 24. Pilot-operated directional valves 22, 24 have a further inlet port EVW2, to which a connecting line 26, 28 is connected; connecting lines 26, 28 lead into a common outlet line 30 which is connected to a working port A of pilot control valve 4. A control line 32, 34, which is connected to a control chamber 36, 38, respectively, of directional valve 2, branches off from an outlet port AVW1 of directional valves 22, 24. A valve spool of directional valve 2 can be acted upon by pilot control pressure via control chambers 36, 38, thereby displacing it.

Directional valve 2 is a continually adjustable 3-port directional valve which can be displaced from its neutral position 0 shown, using the valve spool, in the direction of positions a or b.

Pilot-operated directional valves 22, 24 have a further outlet port AVW2, to which a supply line 40, 42 establishes a control oil connection to an inlet port EW1, EW2, respectively, of a shuttle valve 44. Outlet port EA1 of shuttle valve 44 is connected via a pressure line 46 to a pressure port P of pilot control valve 4, thereby enabling it to be supplied with a supply pressure that corresponds to the pilot control pressure of pilot control assembly 6, i.e. the greater of the pilot control pressures at outlet ports VA1, VA2. Pilot-operated directional valves 22, 24 connect their inlet port EVW1, EVW2 at which the highest control-oil pressure is present to both outlet ports AVW1, AVW2. The same applies for shuttle valve 44; in this case as well, inlet port EW1, EW2 at which the highest control-oil pressure is effective is controlled open toward outlet port EA1.

A control oil discharge line 48 connects a control oil discharge port T of pilot control valve 4 to an outlet port IA of an inverse directional valve 50. Two inlet ports IE1, IE2 of inverse directional valve 50 have a control oil connection via low-pressure lines 52, 54, respectively, to one of the pilot control lines 14, 16, thereby enabling control oil discharge port T of pilot control valve 4 to be connected to one of the pilot control lines 14, 16. In this case, the control oil connection between low-pressure line 52, 54 having the lower pressure and outlet port IS is opened by inverse directional valve 50.

Pilot control valve 4 is an electrohydraulic pressure reducing valve having three ports P, A, T, wherein the outlet pressure present at working port A of pilot control valve 4 is generated by a valve spool of pilot control valve 4 and acts against the force of an electromagnet 56. The valve spool of pilot control valve 4 is preloaded by the force of a spring 58 which likewise acts against electromagnet 56, in the direction of a position in which the connection between outlet line 30 and control oil discharge line 48 is controlled open. When electromagnet 56 is energized, the valve spool is displaced in a direction in which outlet line 30 is connected to pressure line 46.

The control of the valve spool of directional valve 2 of control system 1 is explained in greater detail in the following. To displace the valve spool of directional valve 2 in the direction of position a, control lever 20 of pilot control assembly 6 is actuated in a manner such that a pilot control pressure sets up in pilot control line 14 or 16, the level of which is dependent on the position of control lever 20. The pilot control pressure in pilot control line 14 opens the connection via pilot-operated directional valve 22 to control line 32 and supply line 40. By way of supply line 40, shuttle valve 44, and pressure line 46, the supply pressure that corresponds to the pilot control pressure in pilot control line 14 is present at inlet port P of pilot control valve 4. The pilot control pressure is applied further to the valve spool of directional valve 2 by way of pilot-operated directional valve 22 via control line 32 and control chamber 36. By way of pilot control valve 4, an outlet pressure counteracts the pilot control pressure on the valve spool of directional valve 2, as explained in greater detail below.

To adjust the outlet pressure in outlet line 30, electromagnet 56 of pilot control valve 4 is energized, and therefore a certain effective current flows through its winding. The magnet exerts a force, which is dependent on the current intensity, on the valve spool of pilot control valve 4, the force counteracting the force of spring 58 and the outlet pressure in outlet line 30. This outlet pressure increases until force equilibrium exists at the valve spool. Once this force equilibrium has been reached, the valve spool of pilot control valve 4 assumes a control position in which small movements in one direction or the other are sufficient to connect working port A to pressure port P and/or control oil discharge port T which is connected via control oil discharge line 48 to pilot control line 16 via inverse directional valve 50 and low-pressure line 54, and therefore has a control oil connection with tank 18 via pilot control assembly 6. Depending on the current intensity, an outlet pressure therefore sets up in outlet line 30, this outlet pressure being applied to the valve spool of directional valve 2 via connecting line 28, pilot-operated directional valve 24, control line 34, and control chamber 38, and counteracting the pilot control pressure. A pressure differential between the pilot control pressure and the outlet pressure therefore sets in at the valve spool of directional valve 2. The pressure differential is at a maximum when the outlet pressure is zero, and therefore the valve spool of directional valve 2 is displaced at maximum displacement velocity in the direction of position a of directional valve 2. When the outlet pressure is increased via pilot control valve 4, the displacement velocity of the valve spool decreases. If the outlet pressure is equal to the pilot control pressure, the pressure difference is zero and therefore at a minimum, and so the valve spool of directional valve 2 is held still. The displacement and control of the valve spool of directional valve 2 in the direction of position b takes place as described above, wherein pilot control line 16 is pressurized with pilot control pressure via pilot control assembly 6, while pilot control line 14 is connected to tank 18 via pilot control assembly 6.

Directional valve 2 has a working port WP, a tank port WT, and two outlet ports WA1, WA2. Outlet port WA1 is connected via a working channel 60 to a base-side cylinder chamber 62 of hydraulic cylinder 8, and outlet port WA2 is connected via a working channel 64 to an annular chamber 66 of hydraulic cylinder 8. For example, a pump for supplying pressure medium to hydraulic cylinder 8 is connected to pressure port WP. A piston 68 of hydraulic cylinder 8 is displaced when directional valve 2 is displaced into positions a or b; in positions a, the pressure at pressure port WP is applied to cylinder chamber 62, in positions b, the pressure at pressure port WP is applied to annular chamber 64.

Electromagnet 56 of pilot control valve 4 is controlled by microcontroller 3 via an electrical line 70, thereby enabling the control system to be operated using the EFM (electronic flow matching) principle. According to the EFM principle, valve elements are controlled electrically or electrohydraulically as a function of characteristic curve families that are stored in microcontroller 3. The setpoint values are entered using a joystick which is operated by the operator to control the speed and position of equipment (e.g. arm, shovel) of a working unit. The control performed by microcontroller 3 is dependent on a plurality of input variables. One input variable is the supply pressure of pilot control valve 4 that is tapped by a pressure measuring line 72 at an outlet port EA2 of shuttle valve 44, and is converted by a pressure sensor 74 into an electrical signal I1 which is forwarded via signal line 76 to microcontroller 3. A further input variable for microcontroller 10 is the control pressure of hydraulic cylinder 8. It is tapped at an outlet port AM of a measurement directional valve 78, inlet ports EM1 and EM2 of which are connected via a measuring line 80, 82, respectively, to control channels 60, 64, respectively. The tapped control pressure is directed via outlet port AM of measurement directional valve 78 via a pressure measuring line 84 to a further pressure sensor 86 which converts the pressure that was measured into an electrical signal I2 which is transmitted via signal line 88 to microcontroller 3. A further input variable for microcontroller 3 is the displacement travel of piston 68 of hydraulic cylinder 8, which is converted via a displacement sensor 92 and a displacement transducer 94 into an electrical signal I3 which is transmitted via signal line 96 to microcontroller 3. It is entirely feasible for microcontroller 3 to be supplied with further input variables, and to thereby make EFM control possible, as indicated in FIG. 1 using dashed lines 97.

FIG. 2 shows a schematic circuit diagram of a control system 1 for controlling two actuators via two directional valves 2, 98 according to a second embodiment. Control system 1 of the first embodiment depicted in FIG. 1 is basically presented twice in FIG. 2, wherein pilot control valves 4, 100 are controlled using a common microcontroller 3. First directional valve 2, which is shown on the left in FIG. 2, is adjusted via first pilot control assembly 6 and first pilot control valve 4, and second directional valve 98 is adjusted by second pilot control assembly 102 and second pilot control valve 100, as shown in the first embodiment depicted in FIG. 1. By way of control system 1 shown in FIG. 2, second directional valve 98 can also be adjusted using the pilot control pressure of first pilot control assembly 6, which is explained below with reference to FIG. 3.

To improve clarity, FIG. 3 shows an enlarged section A of control system 1 depicted in FIG. 2. Connecting channels 104, 106, see FIGS. 2 and 3, branch off from pilot control lines 14, 16, respectively, which are connected to first pilot control assembly 6, and are each connected to pressure port SP of a closable switching valve 108, 110, respectively. Switching valve 108, 110 is an electrically adjustable 2-port directional valve which can be brought into a spring-loaded neutral position 0 when de-energized, as shown in FIG. 2, and into a working position a when energized. A connecting line 112, 114 is connected to a working port SA of switching valves 108, 110, respectively, connecting lines 112, 114 each having a control oil connection to an inlet port VE1 of a connecting directional valve 116, 118, respectively. A further inlet port VE2 of connecting directional valves 116, 118 is connected to a first pilot control line section 120, 122, respectively, which is connected to pilot control assembly 102 via outlet ports VA1, VA2, respectively. Outlet port VA of respective connecting directional valves 116, 118 has a control oil connection with a further pilot control line section 124, 126, respectively; as is the case with pilot control lines 14, 16 in the first embodiment depicted in FIG. 1, pilot control line section 124, 126 is connected to inlet ports IE1, IE2, respectively, of an inverse directional valve 128, and to inlet ports EVW1, EVW2, respectively, of a pilot-operated directional valve 130, 132, respectively. Switching valve 108, 110 is connected to a tank 18 via a tank port ST.

In spring-loaded neutral position 0 of switching valves 108, 110, which are adjusted using microcontroller 3, the connection between connecting lines 112, 114 and tank 18 is open, and, in working positions a, the connection between connecting channels 104, 106 and connecting lines 112, 114, respectively, is open. Directional valves 2, 98 are actuated using relevant pilot control assembly 6, 102 and pilot control valves 4, 100, respectively as described with reference to the first embodiment shown in FIG. 1.

To adjust second directional valve 98 using first pilot control assembly 6, switching valve 108, 110, which is connected to pilot control line 14, 16 which is pressurized with pilot control pressure, is opened in working position a, e.g. by being controlled by microcontroller 3. For purposes of explanation, it will be assumed in the following that pilot control line 16 is pressurized with pilot control pressure via pilot control assembly 6, and therefore switching valve 108 is switched in the direction of working positions a. The pilot control pressure is forwarded via connecting channel 104 and switching valve 108 to connecting line 112 which is connected to the connecting directional valve. The latter closes the connection to pilot control line section 120 and opens a control oil connection to second pilot control line section 124. The pilot control pressure is then applied via pilot-operated directional valve 130 to the valve spool of directional valve 98 via control line 134, and is forwarded to pilot control valve 100 as supply pressure via supply line 136, shuttle valve 138, and pressure line 140. By way of pilot control valve 100, as in the first embodiment in FIG. 1, the valve spool of directional valve 98 can be acted upon by an outlet pressure against the pilot control pressure. The pilot control pressure of pilot control assembly 6 is also used, as in the first embodiment in FIG. 1, to control directional valve 2.

To move the valve spool of directional valve 98 in the opposite direction using pilot control assembly 6, the pilot control pressure in pilot control line 14 is forwarded accordingly, as was described above with reference to switching valve 108, via switching valve 110 to directional valve 98 and pilot control valve 100.

The application of the first pilot control pressure of first pilot control assembly 6 on directional valve 98 is interrupted if switching valve 108, 110 is closed, which can be controlled by microcontroller 3 as a function of certain parameters, or if second pilot control assembly 106 is actuated and the second pilot control pressure is higher than the first. In this case, inlet port VE1 of connecting directional valve 116, 118 is closed, and the connection between first pilot control line section 120, 122 and second pilot control line section 124, 126, respectively, is established.

In the above-described embodiments presented in FIGS. 1 and 2, a control system 1 is shown, in the case of which directional valves 2, 98 are adjusted hydraulically using pilot control assemblies 6, 106. This adjustment can be influenced by electrohydraulic pilot control valves 4, 100 via microcontroller 3 (EFM). If the electrohydraulic control is disrupted or faulty, the outlet pressure of pilot control valves 4, 100 that acts on the valve spools of directional valves 2, 98 is equal to, at the maximum, to the pilot control pressure, and therefore the pressure difference is zero at most, and the valve spool is held in equilibrium. As a result, control system 1 is extremely safe since the valve spools of directional valves 2, 98 cannot be moved into any position other than that specified by pilot control assemblies 6, 108, even if an electronic malfunction occurs.

Disclosed herein is a control system comprising a pilot control assembly for controlling a directional valve that includes a first and a second control chamber. The first control chamber is used to displace the directional valve in one direction, and the second control chamber is used to displace the directional valve in the opposite direction, wherein the control chambers are each acted upon by a pilot control pressure of the pilot control assembly. In addition to the pilot control assembly, the control system also includes a pilot control valve for applying an outlet pressure to a control chamber. In this case, the supply pressure of the pilot control valve is the pilot control pressure of the pilot control assembly that is effective in one of the control chambers, and the outlet pressure of the pilot control valve is effective in the other control chamber, wherein the outlet pressure is equal to or less than the pilot control pressure.

1. A control system for controlling a directional valve (2), comprising:
a first control chamber (36) adapted to be acted upon by a pilot control pressure to displace the directional valve (2) in one direction using a pilot control assembly; and
a second control chamber (38) adapted to be acted upon by a pilot control pressure via the pilot control assembly (6) to displace it in the opposite direction; and
a pilot control valve (4) for applying an outlet pressure to a control chamber (36, 38), wherein the supply pressure of the pilot control valve (4) is the pilot control pressure of the pilot control assembly (6) in one of the control chambers (36, 38), and the outlet pressure of the pilot control valve (4) is effective in the other control chamber (36, 38), and is equal to or less than the pilot control pressure.

2. The control system according to claim 1, wherein the pilot control valve (4) is an electromagnetic pressure reducing valve.

3. The control system according to claim 2, wherein the pilot control assembly (6) is connected by a pilot control line (14, 16) to a control chamber (36, 38), respectively, of the directional valve (2), and wherein, using the pilot control assembly (6), one of the pilot control lines (14, 16) is adapted to be connected to a control-oil supply line (12) to supply control oil, and the respective other pilot control line (14, 16) is adapted to be relieved to a tank (18).

4. The control system according to claim 2, wherein a supply line (40, 42) of the pilot control valve (4) has a control-oil connection to the highest-pressure pilot control line (14, 16) of the pilot control assembly (6), wherein the highest-pressure pilot control line (14, 16) is connected to one of the control chambers (36, 38) of the directional valve (2), and the other control chamber (36, 38) can be connected, by adjusting the pilot control valve (4), to the supply line (40, 42) or the pilot control line (14, 16) having the lower pressure.

5. The control system according to claim 1, comprising a cascade of shuttle valves for tapping the higher of the pilot control pressures of the pilot control assembly (6) as the supply pressure of the pilot control valve (4) and for applying the outlet pressure of the pilot control valve (4) to the other control chamber (36, 38).

6. The control system according to claim 3, wherein two outlet ports (VA1, VA2) of the pilot control assembly (6) are each connected to one of the pilot control lines (14, 16) which lead to an inlet port (EVW1) of two pilot-operated directional valves (22, 24), wherein another inlet port (EVW2) of the pilot-operated directional valves (22, 24) is connected via connecting lines (26, 28) and a common outlet line (30) to a working port (A) of the pilot control valve (4), wherein two outlet ports (AVW1, AVW2) of pilot-operated directional valves (22, 24), respectively, are connected via a control line (32, 34), respectively, to one of the control chambers (36, 38) of the directional valve (2), and via the supply line (40, 42), respectively, to an inlet port (EW1, EW2), respectively, of a shuttle valve (44), the outlet port of which is connected to the pressure port (P) of the pilot control valve (4).

7. The control system according to claim 3, wherein the pilot control valve (4) having a tank port (T) is connected via a control-oil discharge line (48) to an outlet port (IA) of an inverse directional valve (50), the inlet ports (IE1, IE2) of which are connected via a low-pressure line (52, 54), respectively, to one of the pilot control lines (14, 16).

8. The control system according to claim 1, wherein a piston-ride side annular chamber (66) of a hydraulic cylinder (8) is connected to a working line (64), and wherein a base-side cylinder chamber (62) of the hydraulic cylinder (8) is connected to another working line (60) of the directional valve (2).

9. The control system according to claim 8, wherein a microcontroller (3) controls the pilot control valve (4) as a function of the displacement travel of a piston (68) of the hydraulic cylinder (8) and/or a control-oil pressure in the highest-pressure working line (60, 62) between the hydraulic cylinder (8) and the directional valve (2) and/or a control-oil pressure in the pressure line (40, 42) toward the pilot control valve (4).

10. A control system for controlling at least two actuators, to each of which a control system according to claim 1 is assigned, wherein the pilot control valve (98) assigned to one actuator is acted upon via a valve system by the pilot control pressure, as the supply pressure, of the first pilot control assembly (6) which is assigned to the other actuator.

11. The control system according to claim 10, wherein the valve system comprises two connecting shuttle valves (116, 118), the inlet ports (VE1, VE2) of which are connected to connecting channels (104, 106), respectively, which branch off from the pilot control lines (14, 16) of the first pilot control assembly, and to pilot control line sections (120, 122) of the second pilot control assembly (108), and wherein the respective outlet port (VA) of the two connecting shuttle valves (116, 118) is connected to the inlet port (EVW1) of piloting shuttle valves (130, 132) and to the inlet port (IE1, IE2) of the inverse shuttle directional valve (128) of the cascade of shuttle valves which is assigned to the pilot control valve (100) for the one actuator.

12. The control system according to claim 11, wherein a closable switching valve (108, 110) is disposed in the control oil flow path between the first pilot control assembly (6) and the respective connecting shuttle valve (116, 118).

13. The control system according to claim 12, wherein the inlet ports of the connecting shuttle valves (116, 118), which are connected to the first pilot control assembly (6), are adapted to be acted upon by the tank pressure via the switching valve (108, 110) or by the pilot control pressure of the first pilot control assembly (6).

14. The control system according to claim 10, wherein the pilot control valves (4, 100) are controlled by a common microcontroller (10).
